(19) United States
(12) Patent Application Publication
(10) Pub. No.: US 2024/0320479 A1
(43) Pub. Date: Sep. 26, 2024

(54) MULTIVARIATE TIME-SERIES SEGMENTATION USING SPARSE GRAPH RECOVERY ALGORITHMS

(71) Applicant: Microsoft Technology Licensing, LLC, Redmond, WA (US)

(72) Inventors: Shima IMANI, Sammamish, WA (US); Harsh SHRIVASTAVA, Redmond, WA (US)

(21) Appl. No.: 18/186,715

(22) Filed: Mar. 20, 2023

(51) Int. Cl. G06N 3/0495

(52) U.S. Cl. CPC G06N 3/0495

(57) ABSTRACT

This disclosure relates to a time series segmentation system that automatically segments multivariate time series data. For example, the time series segmentation system is capable of converting complex and noisy multivariate time series data into segmented multivariate time series by identifying distinct segments within the data. The time series segmentation system operates with linear time complexity in terms of sequence length, which is significantly more efficient than the typical quadratic time complexity required by conventional systems. To illustrate, the time series segmentation system first divides a multivariate time series into portions using time-based windows. The time series segmentation system then converts the windowed subsequences into graph objects using a sparse graph recovery model and utilizes a similarity model to determine segmentation timestamps from the graph objects. The time series segmentation system then uses the segmentation timestamps to convert the multivariate time series data into a segmented multivariate time series.

### BACKGROUND

Time series segmentation involves dividing a time series into multiple segments based on various patterns or characteristics, providing several benefits such as managing long time series effectively and identifying unexpected patterns and trends in data. However, conventional systems do a poor job of segmenting time series data. Further, most conventional systems focus on univariate cases, where a time series includes one variable. Problems with time series segmentation significantly increase when a time series includes multiple variables (i.e., a multivariate time series). Indeed, such systems are inadequate, inefficient, and inflexible in their approach to time series segmentation of multivariate time series data.

### BRIEF DESCRIPTION OF THE DRAWINGS

The detailed description provides one or more implementations with additional specificity and detail through the use of the accompanying drawings, as briefly described below.

FIG. 1 illustrates an example overview of implementing a time series segmentation system to segment multivariate time series data in accordance with one or more implementations.

FIGS. 2A-2B illustrate an example system environment where a time series segmentation system is implemented in accordance with one or more implementations.

FIG. 3 illustrates an example process for dividing multivariate time series data into windowed subsequences in accordance with one or more implementations.

FIG. 4 illustrates an example process for generating graph objects from the windowed subsequences using a graph recovery model in accordance with one or more implementations.

FIG. 5 illustrates an example process for determining segmentation timestamps using a similarity model in accordance with one or more implementations.

FIG. 6 illustrates an example process for generating a segmented multivariate time series using the segmentation timestamps in accordance with one or more implementations.

FIG. 7 illustrates an example process flow for determining refined segmentation timestamps in accordance with one or more implementations.

FIG. 8 illustrates an example process flow for batch processing graph objects in accordance with one or more implementations.

FIG. 9 illustrates an example series of acts for generating segmented multivariate time series data in accordance with one or more implementations.

FIG. 10 illustrates example components included within a computer system.

### DETAILED DESCRIPTION

The present disclosure describes a time series segmentation system that efficiently, accurately, and flexibly segments multivariate time series data. For example, the time series segmentation system is capable of converting multivariate time series data into a segmented multivariate time series that identifies distinct segments in noisy and complex data. Unlike conventional systems, which typically require a quadratic time complexity based on time series length, the time series segmentation system efficiently operates with a linear time complexity in terms of the sequence length. This makes it an ideal solution for handling large datasets, as it can efficiently and accurately process the data without experiencing significant slowdowns.

To briefly elaborate, the time series segmentation system utilizes various techniques and models to generate a segmented multivariate time series data efficiently and accurately. It employs time-based windows to divide the multivariate time series into portions, and a graph recovery model to convert the windowed subsequences into graph objects. Furthermore, it uses a similarity model to determine segmentation timestamps from the graph objects, which are used to convert the multivariate time series into a segmented multivariate time series.

As indicated above, multivariate time series data is commonly used in various areas and industries such as healthcare, engineering, manufacturing, scientific research, finance, health tracking, weather, environmental surveys, and physiological studies, among others. For instance, it is used to monitor patient vital signs and track their health evolution, and individuals often wear health tracking devices that collect multivariate time series data on different parameters such as the number of steps, travel distance, elevation changes, oxygen levels, heart rate, move time, and calories expended.

However, multivariate time series data is complex and often noisy. Additionally, different time series may correlate at some instances and not correlate at other instances, making it challenging to extract useful information from such data. Most conventional systems are primarily designed for univariate time series segmentation and their performance on multivariate data remains largely unsatisfactory. Disclosed implantations of the time series segmentation system overcome these challenges by providing an efficient, accurate, and flexible time series segmentation system for multivariate time series data.

As described in this document, the time series segmentation system provides several technical benefits in terms of computing efficiency, accuracy, and flexibility compared to existing systems. Indeed, the time series segmentation system provides several practical applications that deliver benefits and solve problems associated with segmenting multivariate time series data.

To illustrate, the time series segmentation system utilizes graph objects and models to efficiently and accurately generate segmented multivariate time series data. The time series segmentation system does this by efficiently generating graph objects from short intervals of the multivariate time series data using a graph recovery model. These object graphs can include conditional independence (CI) graphs, which are probabilistic graphical models that include nodes connected by edges to partial correlations between the nodes. Additionally, the time series segmentation system determines segmentation timestamps from the graph objects using a similarity model.

The time series segmentation system achieves segmented multivariate time series in O(N) operations by converting the input time series into a temporal dependency graph objects sequence using a graph recovery model. This is a significant improvement compared to conventional systems that require O(N²) operations at best. The time series segmentation system generates a segmented multivariate time series on a linear scale, in terms of time and computational complexity, unlike conventional systems that require a quadratic scale.

The time series segmentation system also accommodates a wide range of data types and sets by utilizing conditional independence (CI) graphs and other types of graph objects. In various implementations, the time series segmentation system utilizes a cross-domain and/or domain-agnostic multivariate segmentation framework that draws a parallel between the graph nodes and the variables of the time series. Additionally, the combination of flexibility and efficiency in the time series segmentation system makes it highly scalable on any size of dataset.

The time series segmentation system further improves efficiency over conventional systems by enabling batch processing, in addition to utilizing graph objects. In various implementations, the system employs deep-learning sparse graph recovery models like uGLAD, which can convert any number of windowed subsequences into graph objects using a single model with shared parameters, without requiring parallel processing (e.g., not performed by multiple model instances in parallel). By creating a batch of intervals and executing a single run of the uGLAD model in multitask learning mode, the time series segmentation system recovers all graph objects simultaneously, resulting in corresponding temporal dependency graph objects (e.g., dependency graphs) that accurately represent the multivariate time series.

Additionally, the use of graph objects in the time series segmentation system provides interpretable functionality, which is important for many entities analyzing real-world time series data. Unlike many conventional systems that utilize sparse matrices without indications of how variables and values are correlated, the graph objects generated and utilized by the time series segmentation system offer greater interpretability.

This disclosure uses a variety of terms to describe the features and advantages of one or more implementations. For example, “multivariate time series data” refers to a collection of data points that record multiple variables at different points in time. These variables are measured simultaneously over a period of time and can include a wide range of data types, such as numerical, categorical, and text data.

In addition, the term “segmented multivariate time series” refers to a multivariate time series that includes indications of segmented portions within the data. In this document, a segment refers to a consecutive portion of data that corresponds to the same or similar activity or event, which is distinct from just consecutive data within a time window (which is discussed below as a subsequence or windowed time data). A segment can be identified by consistent temporal patterns among the consecutive data points in a multivariate time series.

Throughout the document, various variables are used to represent different aspects of the data. For example, D represents the number of dimensions, variables, concepts, or features in a multivariate time series, sometimes shown as f. N represents the length of the time series, based on time or the number of values. The variable t refers to time and a multivariate time series ranges from t₁ to t₁₀. A multivariate time series T of length N and dimension D is a sequence of real-valued vectors shown as T=t₁, t₂, . . . , t_{N}, where tᵢ∈ [symbol] ^{D}. W refers to a portion of windowed data made up of a subsequence.

A “subsequence” is a smaller section of a larger sequence. In the case of multivariate time series data, a subsequence refers to a local section of a multivariate time series that consists of a continuous subset of its values. For example, a subsequence T_{i,M} of multivariate time series T is a continuous subset of the values from T of length M starting from position i. For instance, the subsequence T_{i,M} is shown as T_{i,M}=tᵢ, tᵢ₊₁, . . . , t_{i+M-1}, where 1≤i≤N−M+1.

A “windowed subsequence” refers to a subsequence selected from a multivariate time series based on a window of fixed size and sliding location. The windowed subsequence moves through the time series with a specified step size (e.g., stride length), allowing for a set of overlapping subsequences to be extracted. The type, location, movement pattern, and size of a window depend on numerous factors, which are provided below. For instance, smaller window sizes with a larger overlap may capture finer-grained patterns but may result in a larger number of subsequences and higher computational complexity. Conversely, a larger window size and smaller overlap may result in a smaller number of subsequences but may miss finer-grained patterns.

With respect to windows, a “stride length” refers to the number of data points that a window shifts or moves to capture different windowed subsequences. For example, the stride length indicates how much a window shifts from a current starting position in the multivariate time series to the next starting position between window captures. To illustrate, a stride length s indicates that if the current subsequence is located at T_{i,M} where i is the starting position of the subsequence from multivariate time series T with length M, then, the next subsequence is T_{i+s,M} with the starting position at i+s.

The terms “graph object” refers to a visual tool, such as a dependency graph, used to visualize relationships between concepts in time series data. For example, a graph object (or sometimes called a visual concept graph) includes a graph, chart, or table showing relationships between different variables, features, or concepts. A graph object can be represented as an adjacency list or adjacency matrix. A graph object includes both positive and negative partial correlations between variables. The edges in a graph object can range in correlation strength from [−1, 1] and different visual effects, such as colors, thicknesses, and patterns can be used to show the magnitudes of connection strength or other correlation scores between variables.

A “timestamp” refers to a unique identifier that represents a specific point in time within a sequence of a multivariate time series. A timestamp includes a data structure that includes information about a specific time in a time series dataset. Similarly, the terms “segmentation timestamp” or “segmented timestamp” refer to a (proposed or actual) starting or ending point of a segment within a segmented multivariate time series.

As used herein, the term “sparse graph recovery” refers to recovering a graph object from data sources. For example, a sparse graph recovery model recovers graph objects from time series data (e.g., subsequences of time series data) by discovering a probabilistic graphical model that potentially shows sparse connections between the D feature of an input sample. Sparse graph recovery models range from generic optimization based sparse graph recovery models to deep-learning sparse recovery models, such as uGLAD.

The term “conditional independence graph objects” (or CI graph objects) refers to a graph object that shows a partial correlation between the nodes or features. For instance, a partial correlation captures a direct dependency between the features (e.g., variables) as it is the conditional probability of the features under consideration given all the other features. In other words, a CI graph object represents dependencies between variables in a multivariate time series while considering the dependencies on other variables.

As used herein, the term “precision matrix” refers to a matrix that correlates variables/concepts/features to other variables/concepts/features within a window of a multivariate time series. In various implementations, a precision matrix is an information matrix that is the inverse of the covariance matrix and is used to model the conditional dependencies between variables in a graphical model. In some cases, the precision matrix can also capture latent correlations between variables.

Additionally, the term “similarity model” refers to one or more functions, algorithms, and/or processes for comparing graph objects (e.g., dependency graphs). In various implementations, a similarity model includes a trajectory tracking algorithm that analyzes how graph objects evolve over intervals to determine multivariate time series segmentation.

As used herein, the term “machine learning” refers to algorithms that model high-level abstractions in data by generating data-driven predictions or decisions from the known input data. Examples of machine-learning models include computer representations that are tunable (e.g., trainable) based on inputs to approximate unknown functions. For instance, a machine-learning model includes a model that utilizes algorithms to learn from, and make predictions on, known data by analyzing the known data to learn to generate outputs that reflect patterns and attributes of the known data. For example, machine-learning models include latent Dirichlet allocation (LDA), multi-arm bandit models, linear regression models, logistical regression models, random forest models, support vector machines (SVG) models, neural networks (convolutional neural networks, recurrent neural networks such as LSTMs, graph neural networks, etc.), or decision tree models.

Additionally, a machine-learning model can include a sparse graph recovery machine-learning model (or simply “model” as used hereafter) that determines correlation strengths between pairs of concepts within sets of digital documents. In some implementations, the sparse graph recovery machine-learning model is a neural network that includes multiple neural network layers. In various implementations, the sparse graph recovery machine-learning model includes a uGLAD model, which is a deep model that solves the graphical lasso objective with improved guarantees in terms of sample complexity and capturing tail distributions.

Additionally, this disclosure describes a time series segmentation system in the context of a network. In this disclosure, a “network” is defined as one or more data links that enable the transport of electronic data between computer systems and/or modules and/or other electronic devices. A network may include public networks such as the Internet as well as private networks. When information is transferred or provided over a network or another communications connection (either hardwired, wireless, or a combination of hardwired or wireless) to a computer, the computer properly views the connection as a transmission medium. Transmission media can include a network and/or data links that can be used to carry needed program code means in the form of computer-executable instructions or data structures and which can be accessed by a general-purpose or special-purpose computer. Combinations of the above are also included within the scope of computer-readable media.

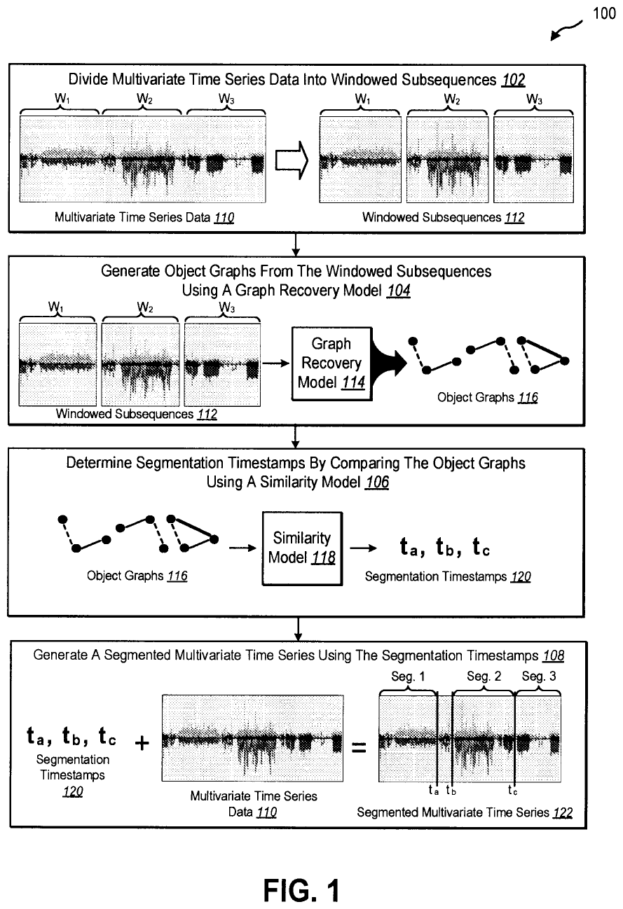

Additional details regarding an example implementation of the time series segmentation system are discussed in connection with the following figures. For example, FIG. 1 illustrates an example overview for implementing a time series segmentation system to segment multivariate time series data in accordance with one or more implementations. As shown, FIG. 1 includes a series of acts 100 that, in many instances, is performed by a time series segmentation system.

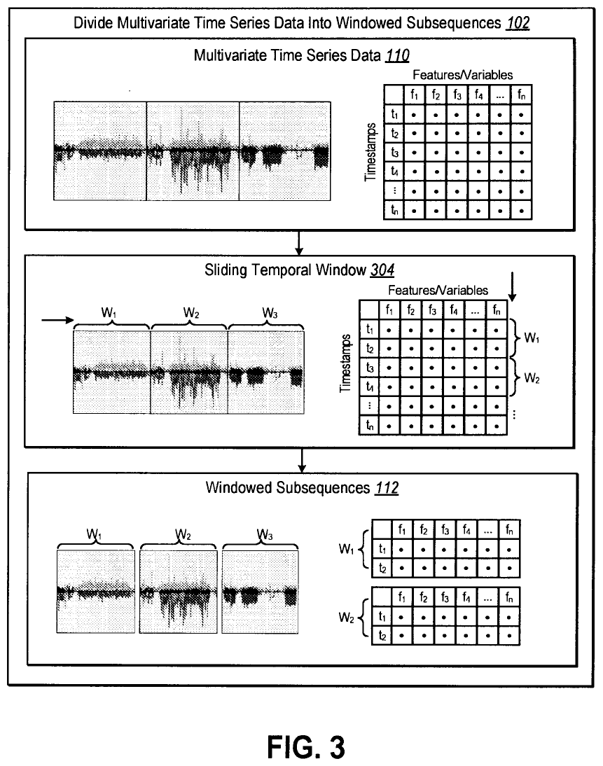

To illustrate, the series of acts 100 includes an act 102 of dividing multivariate time series data into windowed subsequences. For example, the time series segmentation system receives multivariate time series data 110 from one or more data sources or stores. Based on a predetermined window size and type, the time series segmentation system generates windowed subsequences 112 (e.g., from W₁, W₂, and W₃). In various implementations, the time series segmentation system utilizes a fixed window size or length. Additional details regarding generating windowed subsequences from the multivariate time series data are provided below in connection with FIG. 3.

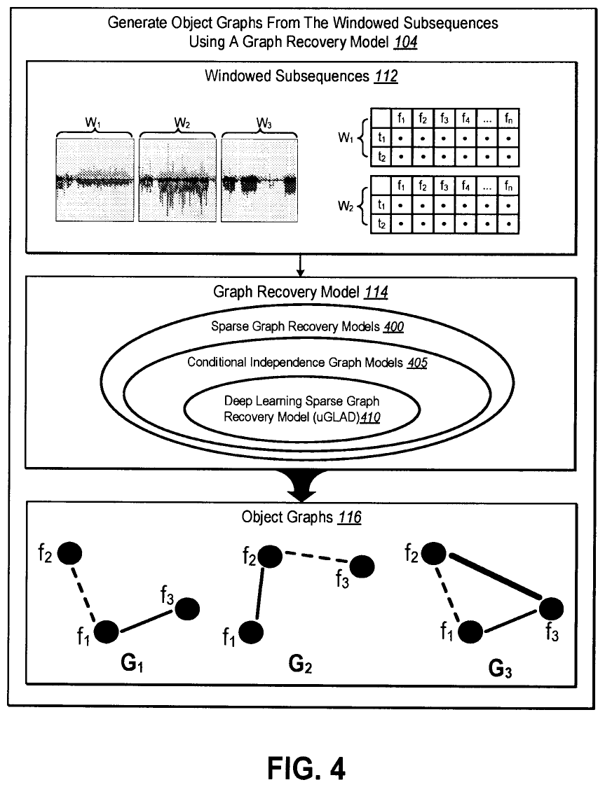

As depicted, the series of acts 100 includes an act 104 of generating object graphs from the windowed subsequences using a graph recovery model. For example, the time series segmentation system utilizes a graph recovery model 114 to recover graph objects 116 (e.g., dependency graphs) from the windowed subsequences 112. In some instances, the time series segmentation system generates the graph objects 116 in a serial or parallel order where the graph recovery model 114 independently and/or individually processes each windowed subsequence. In other instances, the time series segmentation system utilizes the graph objects 116 to process all the windowed subsequences 112 as a single batch simultaneously. Additional details regarding recovering graph objects using a graph recovery model are provided below in connection with FIG. 4. Additional details regarding batch mode processing are provided below in connection with FIG. 8.

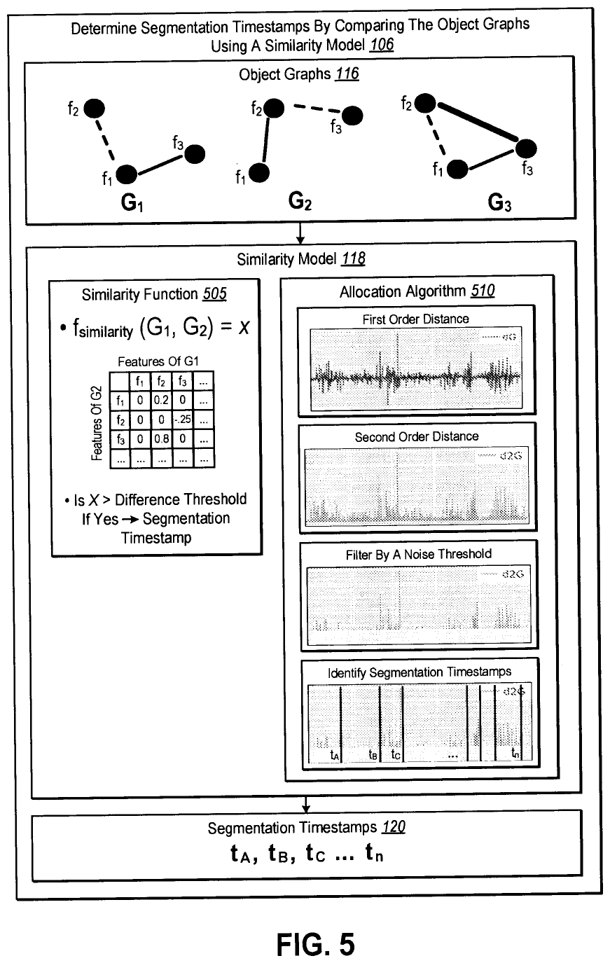

FIG. 1 also shows that the series of acts 100 includes an act 106 of determining segmentation timestamps by comparing the graph objects using a similarity model. For example, the time series segmentation system utilizes a similarity model 118 to determine segmentation timestamps 120 by analyzing and comparing the graph objects 116. For instance, a segmentation timestamp indicates when the data points in a subsequence of the multivariate time series data change temporal patterns or shapes. Additional details regarding determining segmentation timestamps using a similarity model are provided below in connection with FIG. 5.

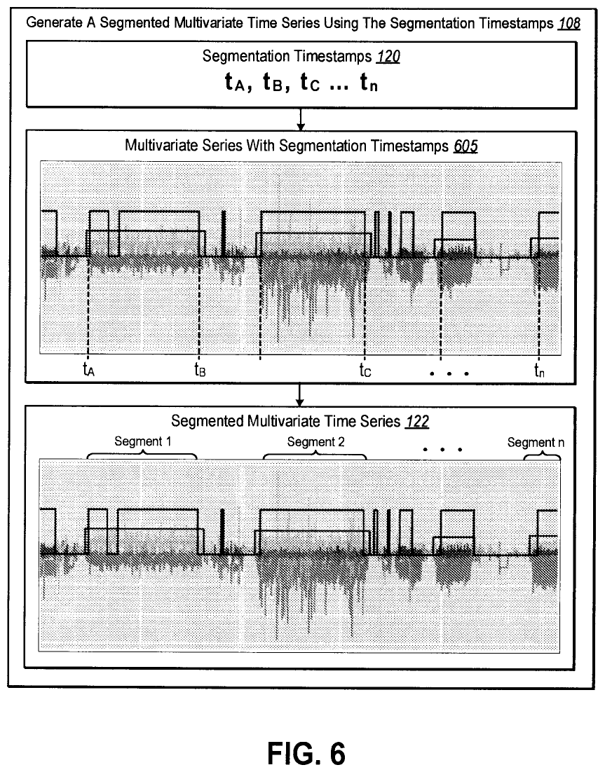

As shown, the series of acts 100 includes an act 108 of generating a segmented multivariate time series using the segmentation timestamps. For example, the time series segmentation system incorporates or applies the segmentation timestamps 120 to the multivariate time series data 110 to generate a segmented multivariate time series 122 that includes indications when different segments occur. Additional details regarding generating segmented multivariate time series are provided below in connection with FIG. 6.

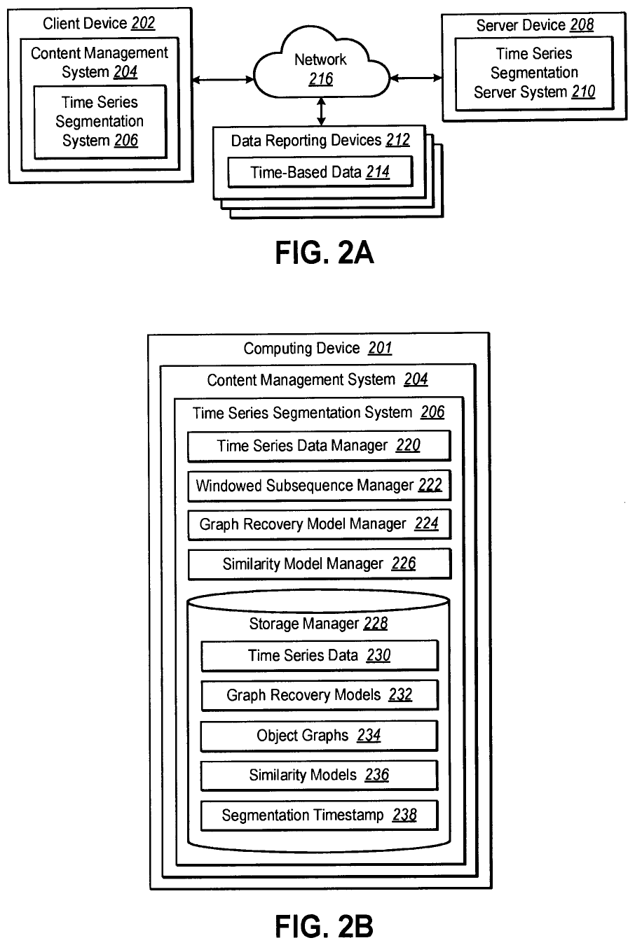

With a general overview of the time series segmentation system in place, additional details are provided regarding the components and elements of the time series segmentation system. To illustrate, FIGS. 2A-2B illustrate an example system environment where a time series segmentation system is implemented in accordance with one or more implementations. While FIGS. 2A-2B show example arrangements and configurations with respect to the time series segmentation system, other arrangements and configurations are possible.

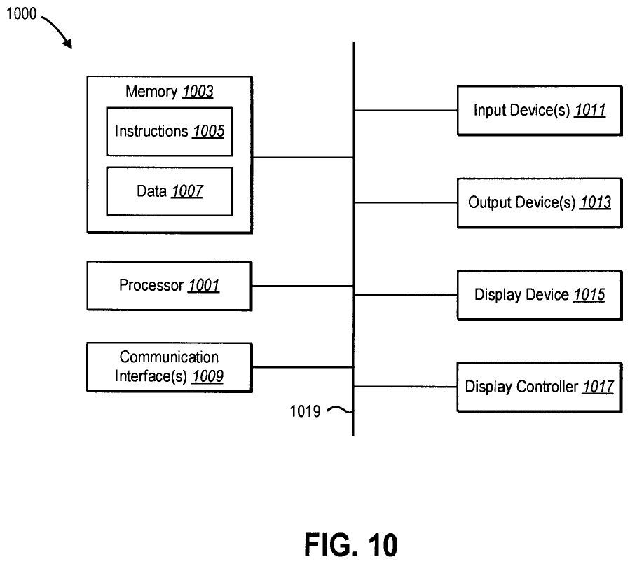

As shown, FIG. 2A includes an environment 200 of a computing system having a client device 202, a server device 208, and data reporting devices 212, which are connected by a network 216. Further details regarding these and other computing devices are provided below in connection with FIG. 10. In addition, FIG. 10 also provides additional details regarding networks, such as the network 216 shown.

In various implementations, the client device 202 is associated with a user (e.g., a user client device), such as a user who interacts with a time series segmentation system 206 to request a segmented multivariate time series. As shown, the client device 202 includes a content management system 204, which performs a variety of functions. For example, in one or more implementations, the content management system 204 facilitates the receiving, storage, and access of multivariate time series data.

As shown, the content management system 204 includes a time series segmentation system 206. In some instances, the time series segmentation system 206 is located outside of the content management system 204. In various implementations, the time series segmentation system 206 generates segmented multivariate time series based on windowed subsequences, graph recovery models, graph objects (e.g., dependency graphs), similarity models, and segmentation timestamps. Additional details and components of the time series segmentation system 206 are provided below in FIG. 2B.

As just mentioned, the content management system 204 may receive and store multivariate time series data for the time series segmentation system 206 to process. In various implementations, the content management system 204 receives time-based data 214 from data reporting devices 212, which collect, monitor, identify, and/or record the time-based data 214 as multivariate time series data. In various implementations, the content management system 204 and/or the time series segmentation system 206 includes one or more of the data reporting devices 212 to monitor and collect time-based data.

As shown, the environment 200 also includes the server device 208. The server device 208 includes a time series segmentation server system 210. For example, in one or more implementations, the time series segmentation server system 210 represents and/or provides similar functionality as described herein in connection with the time series segmentation system 206. In some implementations, the time series segmentation server system 210 supports the time series segmentation system 206 on the client device 202. Indeed, in one or more implementations, the server device 208 includes all, or a portion of, the time series segmentation system 206. For instance, the time series segmentation system 206 on the client device 202 downloads and/or accesses an application from the server device 208 (e.g., one or more deep-learning models) or a portion of a software application.

In some implementations, the time series segmentation server system 210 includes a web hosting application that allows the client device 202 to interact with content and services hosted on the server device 208. To illustrate, in one or more implementations, the time series segmentation server system 210 implements the time series segmentation framework, which includes one or more machine-learning models. For example, the client device 202 (e.g., a mobile device) provides access to a multivariate time series to the time series segmentation server system 210 on the server device 208, which provides back segmentation timestamps and/or a segmented multivariate time series to the client device 202.

As mentioned above, FIG. 2B provides additional details regarding the capabilities and components of the time series segmentation system 206. To illustrate, FIG. 2B shows a computing device 201 that has the content management system 204 and the time series segmentation system 206. For example, the computing device 201 represents either the client device 202 and/or the server device 208 introduced above.

In addition, as shown, the time series segmentation system 206 includes various components and elements. For example, the time series segmentation system 206 includes a time series data manager 220 for accessing, collecting, and displaying multivariate time series data as well as managing the multivariate time series data (i.e., time series data 230). The time series segmentation system 206 also includes a windowed subsequence manager 222, which generates windowed subsequences from multivariate time series data.

Further, the time series segmentation system 206 includes a graph recovery model manager 224, which utilizes graph recovery models 232 to generate graph objects 234 from the time series data 230. Additionally, the time series segmentation system 206 includes a similarity model manager 226 that utilizes one or more similarity models 236 to determine segmentation timestamps 238. Further, the time series segmentation system 206 includes a storage manager 228, which stores various pieces of data and/or models, as shown along with additional data not included in FIG. 2B.

With the foundation of the time series segmentation system 206 in place, additional details regarding various functions of the time series segmentation system 206 will now be described. As noted above, FIGS. 3-6 expand and provide additional details regarding the acts 102-108 described above. For example, FIG. 3 relates to dividing multivariate time series data into windowed subsequences. FIG. 4 relates to generating graph objects from the windowed subsequences using a graph recovery model. FIG. 5 relates to determining segmentation timestamps using a similarity model. FIG. 6 relates to generating a segmented multivariate time series using the segmentation timestamps in accordance with one or more implementations.

As just mentioned, FIG. 3 relates to generating windowed subsequences from a multivariate time series. In particular, FIG. 3 illustrates an example process for dividing multivariate time series data into windowed subsequences in accordance with one or more implementations. As shown, FIG. 3 includes the act 102 of dividing multivariate time series data into windowed subsequences introduced above. The act 102 is further described in connection with the various elements shown.

As shown in the act 102 in FIG. 3, generating the windowed subsequences 112 includes the multivariate time series data 110 and a sliding temporal window 304. For example, the time series segmentation system 206 receives, identifies, or otherwise obtains multivariate time series data 110. Often the multivariate time series data 110 is from events and actions that previously occurred, such that the process of generating segmented multivariate time series data occurs offline. In some implementations, the process occurs in real-time or near real-time. As mentioned above, the time series segmentation system 206 may collect some or all of the multivariate time series data 110 from data reporting devices 212 that record time-based data.

As shown, the multivariate time series data 110 may be represented visually as a graph. Additionally, the multivariate time series data 110 may be represented in a table or matrix form. For example, the multivariate time series data 110 is stored in a precision matrix that plots values of data points of features/variables over time (i.e., recorded at predetermined timestamps). While FIG. 3 shows dots, each entry in the matrix of multivariate time series data 110 can include a value of a data point.

FIG. 3 also includes a sliding temporal window 304. In various implementations, the time series segmentation system 206 divides the multivariate time series data 110 into multiple intervals (i.e., the windowed subsequences) using a sliding temporal window 304. As shown, the time series segmentation system 206 applies multiple sliding windows to the multivariate time series data 110 to generate the windowed subsequences 112.

The sliding temporal window 304 may facilitate one or more windowing operations and be defined by window type, window size, stride length, and starting/ending points. For example, the sliding temporal window 304 can be one of many window types, such as a tumbling window or a hopping window.

A tumbling window segments data points into distinct, consecutive time segments that do not repeat, do not overlap (i.e., non-overlapping), and where a data point cannot belong to more than one window (e.g., W₁ is from 1-5 seconds, W₂ is from 6-10 seconds, W₃ is from 11-15 seconds, etc.). In various implementations, the location of each hop is determined based on stride length. A tumbling window moves or jumps forward in a time series the same distance (e.g., stride length) as the window size of the tumbling window.

A hopping window hops forward in time by a fixed period. Hopping windows may overlap, and data points may belong to multiple windowed subsequences (e.g., W₁ is from 1-5 seconds, W₂ is from 3-7 seconds, W₃ is from 7-10 seconds, etc.). A hopping window has a shorter stride length than the window size. In some instances, a hopping window is referred to as a running or moving window.

In general, the time series segmentation system uses a fixed window size for one instance through a multivariate time series. For example, each of the windowed subsequences 112 is the same length (e.g., same time duration), which often results in the same number of data points. In some implementations, the time series segmentation system 206 uses variable window sizes depending on the number, type, or quality of data points included in a particular portion of the multivariate time series.

In one or more implementations, the time series segmentation system 206 selects the window size based on one or more approaches. For example, the window size is selected to be a predetermined amount or fraction of the total multivariate time series. In some instances, the window size is based on a default time duration based on the type of data in the time series. In various implementations, the window size is based on the number of data points rather than the time duration.

In one or more implementations, as noted below, the time series segmentation system changes the window size between instances or passes through a multivariate time series. For example, the time series segmentation system 206 selects a wide window size to roughly identify segmentation timestamps. Then, the time series segmentation system 206 selects a smaller, refined window size to target particular portions of the multivariate time series on a subsequent pass or interaction.

Other characteristics include stride length and starting/ending points. Stride length is defined and described above. The time series segmentation system 206 uses starting and ending points to cover the entire span of a multivariate time series or a predefined portion, such as within a particular time frame or targeting a particular timestamp.

In one or more implementations, the time series segmentation system 206 performs basic preprocessing for one or more of the variables in a given multivariate time series. For example, the time series segmentation system 206 includes missing value imputation using a forward-filling algorithm in some instances. In some instances, this is done to fill in any missing data points and ensure that the time series data is complete before segmenting it into subsequences.

As noted above, in various implementations, the time series segmentation system 206 partitions the multivariate time series into small subsequences using a fixed window size M and stride length s and runs over the some or all of the time series. In these implementations, the windowed subsequences 112 that result may be represented as B=(N−M+1)/s batches, where B refers to the number of batches, M to the number of samples, and D to the number of variables. In some implementations, the batch of samples is represented as the tensor of size X∈ [symbol] ^{B×M×D}.

FIG. 4 illustrates an example process for generating graph objects (e.g., dependency graphs) from the windowed subsequences using a graph recovery model in accordance with one or more implementations. As shown, FIG. 4 expands on the act 104 of generating graph objects from the windowed subsequences using a graph recovery model. As shown, the act 104 includes using the graph recovery model 114 to generate the graph objects 116 from the windowed subsequences 112.

As mentioned above, graph recovery models generate or recover graph objects that show potential connections between features or variables within the windowed subsequences 112. Indeed, the time series segmentation system 206 aims to recover undirected graphs that capture direct dependence among their nodes or features.

Graph recovery models are often algorithm-based and may employ various methods to recover graph objects. For instance, graph recovery models use methods including regression-based, partial correlation, graphical lasso, Markov network, and/or other types of neural machine learning. For example, the graphical lasso methods include optimization, deep unfolding, and/or tensor-based methods. More particularly, the uGLAD model referred to in this paper utilizes an unsupervised deep-unfolding graphical lasso-based approach to recover conditional independence graphs.

Accordingly, as shown, the graph recovery model 114 includes different levels of graph recovery models. At a general level, the graph recovery model 114 includes sparse graph recovery models 400 to run on the windowed subsequences 112. At the next level are conditional independence graph models 405. At the highest level are deep-learning sparse graph recovery models 410, such as the uGLAD model.

In general, the sparse graph recovery models 400 recover graph objects (e.g., dependency graphs) from input data (e.g., the windowed subsequences 112). However, these graph objects may not strongly indicate correlations between features. The conditional independence graph models 405, on the other hand, recover graph objects that include direct dependencies between features by leveraging the concept of conditional independence (CI). The CI property asserts that two variables are independent of each other given a third variable. In various implementations, the conditional independence graph models 405 and the deep-learning sparse graph recovery models 410 include neural networks that enable adaptive choices of hyperparameters, which in turn improves their efficiency and accuracy in generating graph objects. The deep-learning sparse graph recovery models 410 generate CI graph objects as well as provide increased efficiency and accuracy in generating graph objects, as also discussed below.

As mentioned above, the windowed subsequences 112 may be represented as input X. In these cases, the time series segmentation system 206 utilizes the graph recovery model 114 to run on the input (i.e., X) and outputs a corresponding set of graphs, whose adjacency matrix is represented here by the tensor P∈ [symbol] ^{B×D×D}. In various implementations, the time series segmentation system 206 utilizes the conditional independence graph models 405 and/or the deep-learning sparse graph recovery models 410 to ensure the model runs efficiently and that the graph objects 116 capture direct dependencies between the features (e.g., nodes).

To elaborate, CI graph objects capture partial correlations between the features that model direct dependencies between them. Further, the nodes in a CI graph object represent features that are connected by edges having edge weights that include partial correlation values (e.g., ranging from [−1, 1]) signaling positive or negative partial correlation information between nodes. The time series segmentation system 206 uses the edge weights and/or partial correlation values to determine segmentation predictions. Additionally, the partial correlation values enable graph objects (e.g., dependency graphs) to provide understanding and transparency to users by being displayed visually.

As mentioned above, in various implementations, the time series segmentation system 206 utilizes the deep-learning sparse graph recovery models 410. One example of a deep-learning sparse graph recovery model is uGLAD, which employs deep-unfolding (or unrolled algorithm) and is an unsupervised extension of a similar GLAD model. These types of deep-learning sparse graph recovery models 410 solve the graphical lasso (i.e., least absolute shrinkage and selection operator) problem through optimization.

In various instances, the deep-learning sparse graph recovery models 410 utilize a tensor-based implementation that allows for multitask learning and enables a single model (e.g., a single instance) to recover the entire batch of data simultaneously (e.g., batch mode or batch processing). Furthermore, the time series segmentation system 206 shares parameters of the model over the different graph recovery tasks, which ensures more robustness to anomalies and noise in the data. Indeed, the deep-learning sparse graph recovery models 410 are sparse graph recovery machine-learning models that robustly handle missing values by leveraging the multi-task learning ability of the model as well as provide a multi-task learning mode that solves the graphical lasso objective to recover multiple graphs with a single model (e.g., batch mode).

As shown at the bottom of FIG. 4, the graph objects 116 include nodes representing the features and edges that show direct positive or negative partial correlations between the features. In some instances, a graph object is represented as G. As illustrated, FIG. 4 shows a first graph object G₁, a second graph object G₂, and a third graph object G₃.

FIG. 5 illustrates an example process for determining segmentation timestamps using a similarity model in accordance with one or more implementations. As shown, FIG. 5 expands on the act 106 of determining segmentation timestamps by comparing the graph objects (e.g., dependency graphs) using a similarity model. As shown, the act 106 includes using the similarity model 118 to determine the segmentation timestamps 120 from the graph objects 116.

Conceptually, the similarity model 118 compares two or more of the graph objects 116 to identify when a meaningful change occurs between their corresponding correlations. Often the similarity model 118 compares consecutive graph objects, although this is not strictly required. When a change is detected, in some instances, the time series segmentation system 206 sets the time of one of the graph objects (e.g., the end of a first graph object or the start of a second graph object) as a segmentation timestamp.

More specifically, the similarity model 118 includes different functions, models, and algorithms to determine the segmentation timestamps 120. Among those shown, the similarity model 118 includes a similarity function 505 and an allocation algorithm 510.

In various implementations, the similarity function 505 generates an adjacency matrix and uses it to determine an F_{similarity} score. To illustrate, consider two graph objects, G₁ and G₂. The time series segmentation system 206 utilizes the similarity function 505 to determine an adjacency matrix, X, between G₁ and G₂.

In various implementations, the adjacency matrix determines the difference in values between each feature connection. To illustrate, suppose the first graph object, G₁, has a value of 0.8 between a second feature, f₂, and a third feature, f₃ (e.g., the edge between f₂ and f₃ has a correlation value of 0.8). Also, suppose the second graph object, G₂, has a value of 0.75 between the second feature, f₂, and the third feature, f₃. Here, the adjacency matrix between G₁ and G₂ shows a difference of −0.05. The adjacency matrix can indicate the changes, if any, between G₁ and G₂. As shown, FIG. 5 includes an example adjacency matrix in connection with the similarity function 505.

Additionally, in various implementations, the similarity function 505 determines if the differences between two graph objects satisfy a difference threshold. To elaborate, in some implementations, the time series segmentation system 206 combines one or more of the scores from an adjacency matrix to determine if the combined value satisfies a difference threshold. For example, the time series segmentation system 206 sums up the absolute value of each entry in an adjacency matrix to determine if the combined sum is greater than or equal to the difference threshold. In various implementations, the time series segmentation system 206 determines if any one entry satisfies the same or a different difference threshold (e.g., there must be a significant change between at least one feature pair between the two graph objects).

When the difference threshold is satisfied, then the time series segmentation system 206 uses the similarity function 505 to identify a segmentation timestamp. For example, when two compared graph objects are found to have a significant difference, the time series segmentation system 206 knows at least four timestamps: the start of the first graph object, the end of the first graph object, the start of the second graph object, and the end of the second graph object. Accordingly, the time series segmentation system 206 may select one of these times within this range as a segmentation timestamp. In some implementations, the time series segmentation system 206 selects a segmentation timestamp between two of the timestamps.

In various instances, the time series segmentation system 206 uses different methods for selecting a segmentation timestamp based on the window type. For example, for a tumbling window where windowed subsequences do not overlap, the end of the first graph object and the start of the second graph object are the same timestamp for consecutive windows. If the windows are not consecutive, the time series segmentation system 206 may select a timestamp between the two windows for the segmentation timestamps. For a hopping window, the data points overlap, and the time series segmentation system 206 may average between the start of the first graph object and the start of the second graph object as the segmentation timestamp.

In some implementations, the time series segmentation system 206 utilizes an allocation algorithm 510 for the similarity model 118. In general, the allocation algorithm 510 uses a multi-step framework to identify segmentation timestamps 120. For example, the allocation algorithm 510 determines a first order distance of multiple graph objects and determines a second order distance by taking the absolute value of the first order distance. Next, as shown, the allocation algorithm 510 filters by a noise threshold to remove data below a noise threshold. The allocation algorithm 510 then identifies the segmentation timestamps 120 from the remaining data.

In additional detail, the time series segmentation system 206 determines a first-order distance sequence, dG∈ [symbol] ^{B} by finding the distance of the consecutive graphs in the temporal graph series G. For each entry, b∈Bb∈B of dG, the time series segmentation system 206 measures the distance between its recovered graph and the next graph object as shown below, where weights are the partial correlation values of the edges of the CI graph objects.

$$dG [ b ] = distance ( {G}_{b} , {G}_{b + 1} ) = {\sum }_{p , q} ( {G}_{b} [ p , q ] ) ∀ p , q ∈ \{ 1 , ... , B \}$$

Further, given the sequence dG, the time series segmentation system 206 computes the second-order distance sequence d2G by applying a second distance operation, such as the formulation shown below.

$$d 2 G [ b ] = abs ( dG [ b ] - dG [ b - 1 ] ) , ∀ b ∈ ( 1 , B )$$

In various implementations, the first-order distance measures the change between each recovered graph and its next neighbor, while the second-order distance highlights potential segmentation points.

In various instances, the time series segmentation system 206 then utilizes the allocation algorithm 510 to determine the final segmentation points from the d2G sequence. For example, in some instances, the time series segmentation system 206 filters out small noises in d2G by applying a noise threshold, which is conservative in many instances.

Additionally, in one or more implementations, the allocation algorithm 510 sequentially traverses the sequence d2G and marks one or more of the segmentation timestamps 120 for non-zero values. In some implementations, the allocation algorithm 510 disregards changes representing potential segmentation points when the change occurs within a predetermined time frame and/or if the changes occur less than a threshold number of times (e.g., 5 times) within the window size.

In various implementations, the time series segmentation system 206 coordinates the similarity model 118 with the graph recovery model 114 to determine how to process the graph objects 116 to generate segmentation timestamps 120. For instance, if the graph recovery model 114 generates conditionally independent graph objects, the similarity model 118 applies different methods to determine the segmentation timestamps 120 than if the graph recovery model 114 did not generate CI graph objects.

FIG. 6 illustrates an example process for generating a segmented multivariate time series using the segmentation timestamps in accordance with one or more implementations. As shown, FIG. 6 elaborates on the act 108 of generating a segmented multivariate time series using the segmentation timestamps. As shown, the act 108 includes the segmentation timestamps 120, a multivariate time series with segmentation timestamps 605, and the segmented multivariate time series 122.

In various implementations, the time series segmentation system 206 adds, overlays, incorporates, and/or otherwise applies the segmentation timestamps 120 to the multivariate time series data 110 to generate the multivariate time series with segmentation timestamps 605. As shown, the multivariate time series with segmentation timestamps 605 applies the segmentation timestamps 120 to the multivariate time series data 110 to identify the beginning and/or end of a segment. In this way, the time series segmentation system 206 generates the segmented multivariate time series 122.

In various implementations, the segmented multivariate time series 122 includes labels or other indications denoting different segments. For example, FIG. 6 shows that the segmented multivariate time series 122 includes a first segment, Segment 1, and a second, Segment 2, among other segments not labeled.

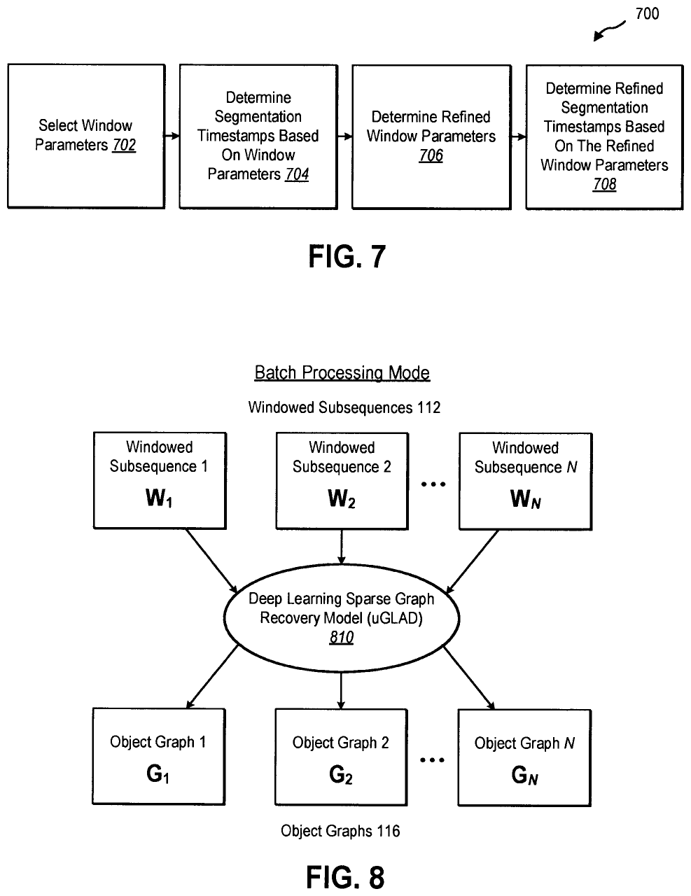

FIG. 7 illustrates an example process flow for determining refined segmentation timestamps in accordance with one or more implementations. For example, FIG. 7 includes a series of acts 700 that provides high-level actions of the time series segmentation system 206 for determining segmentation timestamps.

As shown, the series of acts 700 includes an act 702 of selecting window parameters. For example, the time series segmentation system 206 selects a window size using one or more approaches described above. For instance, the time series segmentation system 206 selects a wider window size that is a percentage of the total duration of a multivariate time series. As mentioned, in some instances, the window size is based on the type of multivariate time series data.

As also shown, the series of acts 700 includes an act 704 of determining segmentation timestamps based on the window parameters. For example, the time series segmentation system 206 performs the actions described above of dividing a multivariate time series based on the window size, generating graph objects, and determining differences in the graph objects to determine segmentation timestamps.

While helpful, in some implementations, the segmentation timestamps 120 may imprecisely identify when a segment within the multivariate time series data changes. For example, a segmentation timestamp can be up to a window size away from the precise moment of change. Accordingly, the time series segmentation system 206 may repeat the above processes with a refined, targeted approach.

To illustrate, the series of acts 700 includes an act 706 of determining refined window parameters. In general, the time series segmentation system 206 changes the parameters of the window to better identify the precise moment a change occurred in a multivariate time series. For example, in some instances, the time series segmentation system 206 determines a smaller window size. In various instances, the time series segmentation system 206 determines to employ additional and/or overlapping windows. In select instances, the time series segmentation system 206 determines to add, or modify in place of changing the window size, the window type (e.g., from a tumbling window to a hopping window). In some implementations, the time series segmentation system 206 varies by stride length.

Additionally, the time series segmentation system 206 may focus on subsequences surrounding the previously determined segmentation timestamps. For example, the time series segmentation system 206 applies a refined window to the graph objects from which a segment time was determined (and, in some cases, new by graph objects) while omitting other graph objects. In this manner, the time series segmentation system 206 conserves computing resources and time.

As shown, the series of acts 700 includes an act 708 of determining refined segmentation timestamps based on the refined window parameters. For example, the time series segmentation system 206 determines refined segmentation timestamps that more accurately indicate the precise location of a segment change within the multivariate time series.

The time series segmentation system 206 may repeat this process to continue to further refine the locations of the segmentation timestamps. Further, because the time series segmentation system 206 is so much more efficient than conventional systems, the time series segmentation system 206 can repeat this process numerous times and still be more efficient.

FIG. 8 illustrates an example process flow for batch processing graph objects in accordance with one or more implementations. As shown, FIG. 8 provides an example of the time series segmentation system 206 applying batch processing mode. As noted above, in various implementations, the time series segmentation system 206 utilizes deep-learning sparse graph recovery models such as uGLAD to convert any number of windowed subsequences into graph objects in a single run, without needing parallel processing (e.g., not performed by multiple model instances in parallel).

To illustrate, FIG. 8 shows windowed subsequences 112 (i.e., W₁, W₂, . . . , W_{N}), a deep-learning sparse graph recovery model 810, and graph objects 116 (i.e., G₁, G₂, . . . , G_{N}). For example, the windowed subsequences 112 are formed as input matrices and provided to the deep-learning sparse graph recovery model 810 in a single batch. The deep-learning sparse graph recovery model 810 generates a corresponding number of graph objects in a single pass or instance of the model using shared parameters.

In various implementations, the deep-learning sparse graph recovery model 810 is one of the examples of the deep-learning sparse graph recovery models 410 described above. For instance, the deep-learning sparse graph recovery model 810 is trained with batches to learn parameter sharing and transfer learning when batch processing is performed.

In various implementations, the time series segmentation system 206 executes the deep-learning sparse graph recovery model 810 (e.g., uGLAD) in batch mode to recover and/or obtain all the underlying precision matrices (e.g., the windowed subsequences 112) at once/simultaneously, without the need for parallel processing.

In some implementations, the time series segmentation system 206 may follow θ←uGLAD(X), where θ∈ [symbol] ^{B×M×D}. Additionally, in these implementations, the time series segmentation system 206 utilizes parameter sharing across the different tasks to help maintain robustness against noisy data and facilitate transfer learning. By using the deep-learning sparse graph recovery model 810, the time series segmentation system 206 obtains a series of temporal CI graph objects represented by the adjacency matrices G=[G₁, G₂, . . . , G_{B}]∈ [symbol] ^{B×D×D} using a partial correlation matrix P. Further, each entry of the adjacency matrix is equal to the partial correlation value, G_{b}[p, q]=ρ(Dₚ, D_{q}) for the b^{th} batch, where D^{k} represents the k^{th} time series variable.

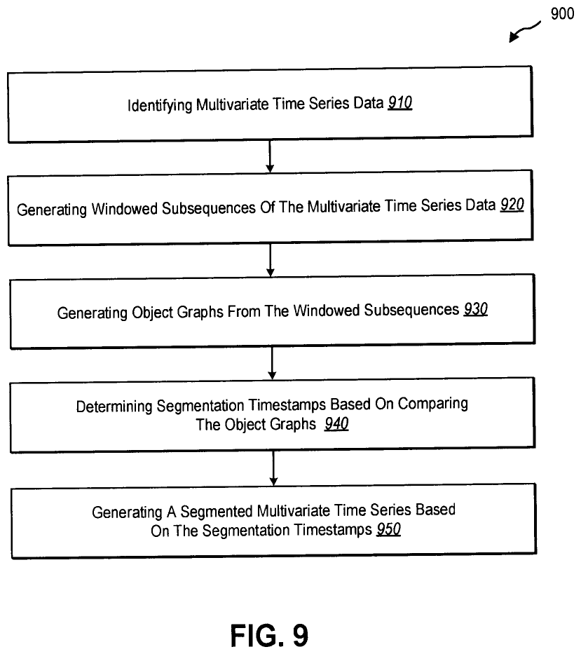

Turning now to FIG. 9, this figure illustrates an example flowchart that includes a series of acts 900 for utilizing the time series segmentation system 206 in accordance with one or more implementations. In particular, FIG. 9 illustrates an example series of acts for generating segmented multivariate time series data in accordance with one or more implementations.

While FIG. 9 illustrates acts according to one or more implementations, alternative implementations may omit, add to, reorder, and/or modify any of the acts shown. Further, the acts of FIG. 9 can be performed as part of a method (e.g., a computer-implemented method). Alternatively, a non-transitory computer-readable medium can include instructions that, when executed by a processing system comprising a processor, cause a computing device to perform the acts of FIG. 9. In still further implementations, a system (e.g., a processing system comprising a processor) can perform the acts of FIG. 9.

In one or more implementations, the system includes multivariate time series data, a sparse graph recovery model that generates graph objects from portions of multivariate time series data, and/or a similarity model that determines differences between two or more graph objects. In various implementations, the system includes a processor and a computer memory including instructions that, when executed by the processor, cause the system to carry out various operations.

As shown, the series of acts 900 includes an act 910 of identifying multivariate time series data. For instance, in example implementations, the act 910 includes obtaining, accessing, receiving, loading, and/or recording multivariate time series data. In various implementations, the act 910 includes receiving, multivariate time series data from one or more data sources.

As further shown, the series of acts 900 includes an act 920 of generating windowed subsequences of the multivariate time series data. For instance, in example implementations, the act 920 involves grouping portions of multivariate time series data by a window size to generate windowed subsequences of the multivariate time series data. In various implementations, the window size corresponds to an overlapping window, and a first windowed subsequence and a second windowed subsequence includes duplicative data. In some implementations, the window size corresponds to a non-overlapping window, and a first windowed subsequence and a second windowed subsequence include non-duplicate data.

As further shown, the series of acts 900 includes an act 930 of generating graph objects from the windowed subsequences. For instance, in example implementations, the act 930 involves generating graph objects from the windowed subsequences utilizing a sparse graph recovery model. In some implementations, the act 930 includes utilizing a conditional independence sparse graph recovery model that generates graph objects that exhibit partial correlation between variables.

In various implementations, the act 930 includes generating a visual graph of nodes and edges, where the edges indicate a positive or a negative partial correlation between connected nodes. In some implementations, the act includes generating an adjacency matrix or an adjacency list indicating connected nodes correlations between corresponding nodes and edges between two graph objects. In one or more implementations, the act 930 also includes generating multiple graph objects from the windowed subsequences at a same time as part of a batch operation that utilizes one instance of the sparse graph recovery model using shared parameters. Furthermore, the parameters of the model are shared over the different graph recovery tasks, which ensures more robustness to anomalies and noise in the data. In some instances, the sparse graph recovery model is an unsupervised deep-learning sparse graph recovery model trained to generate batches of graph objects.

As further shown, the series of acts 900 includes an act 940 of determining segmentation timestamps based on comparing the graph objects. For instance, in example implementations, the act 940 involves determining one or more segmentation timestamps when one or more segment changes in the multivariate time series data occurred based on comparing the graph objects utilizing a similarity model. In one or more implementations, the act 940 includes comparing a first graph object to a second graph object utilizing the similarity model to determine that a difference between the first graph object and the second graph object satisfies a difference threshold and determining a first segmentation timestamp based on a segmentation timestamp of the first graph object.

In some implementations, the similarity model includes an allocation algorithm that determines the one or more segmentation timestamps based on determining a first order distance and a second order distance from the graph objects. In various implementations, the first order distance captures a distance between consecutive graph objects and the second order distance generates absolute values based on the first order distance. In various implementations, the allocation algorithm further includes reducing the second order distance by a filtering out sequence values below a noise threshold to generate a filtered sequence and traversing the filtered sequence for non-zero values to identify the one or more segmentation timestamps.

As further shown, the series of acts 900 includes an act 950 of generating a segmented multivariate time series based on the segmentation timestamps. For instance, in example implementations, the act 950 involves generating a segmented multivariate time series by segmenting the multivariate time series data based on the one or more segmentation timestamps.

In various implementations, the act 950 includes generating, using a refined window size, additional windowed subsequences from the multivariate time series data based on the one or more segmentation timestamps, wherein the refined window size is smaller than the window size and determining one or more refined segmentation timestamps from the additional windowed subsequences updating locations of segments within the segmented multivariate time series based on the one or more refined segmentation timestamps.

In some implementations, the series of acts 900 includes additional acts. For example, the series of acts 900 includes the acts of generating a first windowed subsequence and a second windowed subsequence from multivariate time series data based on a window size, generating a first graph object and a second graph object from the first windowed subsequence and the second windowed subsequence utilizing a sparse graph recovery model, determining a segmentation timestamp based on when a segment change occurred based on comparing the first graph object and the second graph object utilizing a similarity model, and generating a segmented multivariate time series by segmenting the multivariate time series data based on the segmentation timestamp.

FIG. 10 illustrates certain components that may be included within a computer system 1000. The computer system 1000 may be used to implement the various computing devices, components, and systems described herein. As used herein, a “computing device” refers to electronic components that perform a set of operations based on a set of programmed instructions. Computing devices include groups of electronic components, client devices, server devices, etc.

In various implementations, the computer system 1000 represents one or more of the client devices, server devices, or other computing devices described above. For example, the computer system 1000 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1000 includes a processing system including a processor 1001. The processor 1001 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1001 may be referred to as a central processing unit (CPU). Although the processor 1001 shown is just a single processor in the computer system 1000 of FIG. 10, in an alternative configuration, a combination of processors (e.g., an ARM and DSP) could be used.

The computer system 1000 also includes memory 1003 in electronic communication with the processor 1001. The memory 1003 may be any electronic component capable of storing electronic information. For example, the memory 1003 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1005 and the data 1007 may be stored in the memory 1003. The instructions 1005 may be executable by the processor 1001 to implement some or all of the functionality disclosed herein. Executing the instructions 1005 may involve the use of the data 1007 that is stored in the memory 1003. Any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during the execution of the instructions 1005 by the processor 1001.

A computer system 1000 may also include one or more communication interface(s) 1009 for communicating with other electronic devices. The one or more communication interface(s) 1009 may be based on wired communication technology, wireless communication technology, or both. Some examples of the one or more communication interface(s) 1009 include a Universal Serial Bus (USB), an Ethernet adapter, a wireless adapter that operates in accordance with an Institute of Electrical and Electronics Engineers (IEEE) 1002.11 wireless communication protocol, a Bluetooth® wireless communication adapter, and an infrared (IR) communication port.

A computer system 1000 may also include one or more input device(s) 1011 and one or more output device(s) 1013. Some examples of the one or more input device(s) 1011 include a keyboard, mouse, microphone, remote control device, button, joystick, trackball, touchpad, and light pen. Some examples of the one or more output device(s) 1013 include a speaker and a printer. A specific type of output device that is typically included in a computer system 1000 is a display device 1015. The display device 1015 used with implementations disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For clarity, the various buses are illustrated in FIG. 10 as a bus system 1019.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the time series segmentation system 206. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include, for example, instructions and data that, when executed by a processor, cause a general-purpose computer, special-purpose computer, or special-purpose processing device to perform a certain function or group of functions. In some implementations, computer-executable instructions are executed by a general-purpose computer to turn the general-purpose computer into a special-purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium including instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for generating segmented multivariate time series data comprising:
grouping portions of multivariate time series data by a window size to generate windowed subsequences of the multivariate time series data;
generating graph objects from the windowed subsequences utilizing a sparse graph recovery model;
determining one or more segmentation timestamps when one or more segment changes in the multivariate time series data occurred based on comparing the graph objects utilizing a similarity model; and
generating a segmented multivariate time series by segmenting the multivariate time series data based on one or more segmentation timestamps.

2. The computer-implemented method of claim 1, further comprising:
comparing a first graph object to a second graph object utilizing the similarity model to determine that a difference between the first graph object and the second graph object satisfies a difference threshold; and
determining a first segmentation timestamp based on a segmentation timestamp of the first graph object.

3. The computer-implemented method of claim 1, wherein generating the graph objects from the windowed subsequences includes generating a visual graph of nodes and edges, where the edges indicate a positive or a negative partial correlation between connected nodes.

4. The computer-implemented method of claim 1, wherein generating the graph objects from the windowed subsequences includes generating an adjacency matrix indicating partial correlations between corresponding nodes and edges between two graph objects.

5. The computer-implemented method of claim 1, further comprising generating multiple graph objects from the windowed subsequences at a same time as a batch operation that utilizes one instance of the sparse graph recovery model and shared parameters.

6. The computer-implemented method of claim 1, wherein generating the graph objects from the windowed subsequences includes utilizing a conditional independence sparse graph recovery model that generates graph objects that exhibit partial correlation between variables.

7. The computer-implemented method of claim 1, further comprising:
generating, using a refined window size, additional windowed subsequences from the multivariate time series data based on the one or more segmentation timestamps, wherein the refined window size is smaller than the window size;
determining one or more refined segmentation timestamps from the additional windowed subsequences; and
refining locations of segments within the segmented multivariate time series based on the one or more refined segmentation timestamps.

8. The computer-implemented method of claim 1, wherein the similarity model includes an allocation algorithm that determines the one or more segmentation timestamps based on determining a first order distance and a second order distance from the graph objects.

9. The computer-implemented method of claim 8, wherein:
the first order distance captures a distance between consecutive graph objects; and
the second order distance generates absolute values based on the first order distance.

10. The computer-implemented method of claim 8, wherein the allocation algorithm further comprises:
reducing the second order distance by a filtering out sequence values below a noise threshold to generate a filtered sequence; and
traversing the filtered sequence for non-zero values to identify the one or more segmentation timestamps.

11. A system comprising:
multivariate time series data;
a sparse graph recovery model that generates graph objects from portions of multivariate time series data;
a similarity model that determines differences between two or more graph objects;
a processor; and
a computer memory comprising instructions that, when executed by the processor, cause the system to carry out operations comprising:
generating windowed subsequences of the multivariate time series data by grouping portions of the multivariate time series data a time-based window size;
generating graph objects from the windowed subsequences utilizing the sparse graph recovery model;
determining one or more segmentation timestamps based on the graph objects utilizing the similarity model; and
generating a segmented multivariate time series by segmenting the multivariate time series data based on the one or more segmentation timestamps.

12. The system of claim 11, further comprising instructions that, when executed by the processor, cause the system to carry out an operation comprising generating multiple graph objects from the windowed subsequences at a same time as part of a batch operation that utilizes one instance of the sparse graph recovery model and shared parameters.

13. The system of claim 12, wherein the sparse graph recovery model is an unsupervised deep-learning sparse graph recovery model trained to generate batches of object graph dependency graphs.

14. The system of claim 12, wherein the sparse graph recovery model generates conditional independent graph objects that exhibit partial correlation between variables.

15. The system of claim 12, wherein generating the graph objects from the windowed subsequences includes generating a visual graph of nodes and edges, where the edges indicate a positive or a negative partial correlation between connected nodes.

16. The system of claim 11, further comprising instructions that, when executed by the processor, cause the system to carry out an operation comprising:
generating, using a refined window size, additional windowed subsequences from the multivariate time series data based on the one or more segmentation timestamps, wherein the refined window size is smaller than the time-based window size;
determining one or more refined segmentation timestamps from the additional windowed subsequences; and
updating locations of segments within the segmented multivariate time series based on the one or more refined segmentation timestamps.

17. A computer-implemented method for generating segmented multivariate time series data comprising:
generating a first windowed subsequence and a second windowed subsequence from multivariate time series data based on a window size;
generating a first graph object and a second graph object from the first windowed subsequence and the second windowed subsequence utilizing a sparse graph recovery model;
determining a segmentation timestamp based on when a segment change occurred based on comparing the first graph object and the second graph object utilizing a similarity model; and
generating a segmented multivariate time series by segmenting the multivariate time series data based on the segmentation timestamp.

18. The computer-implemented method of claim 17, wherein the window size corresponds to an overlapping window, and wherein the first windowed subsequence and the second windowed subsequence include duplicative data.

19. The computer-implemented method of claim 17, wherein the window size corresponds to a non-overlapping window, and wherein the first windowed subsequence and the second windowed subsequence include non-duplicate data.

20. The computer-implemented method of claim 17, further comprising generating the first graph object and the second graph object in a single batch operation utilizing the sparse graph recovery model based on the first windowed subsequence and the second windowed subsequence.
